(19) United States
(12) Patent Application Publication
(10) Pub. No.: US 2014/0268685 A1
(43) Pub. Date: Sep. 18, 2014

(54) ILLUMINATED SAFETY VEST

(71) Applicant: LIGHTKNIGHT INTERNATIONAL LIMITED, St. Johns (NZ)

(72) Inventor: Sigrid Alice Sylvia McLisky, Auckland (NZ)

(73) Assignee: LIGHTKNIGHT INTERNATIONAL LIMITED, Auckland (NZ)

(21) Appl. No.: 14/352,042

(22) PCT Filed: Oct. 18, 2012
(86) PCT No.: PCT/IB2012/055680

§ 371 Date: Apr. 15, 2014

(30) Foreign Application Priority Data
Oct. 18, 2011 (NZ) 595802
Oct. 18, 2011 (NZ) 595803
Oct. 18, 2011 (NZ) 595804
May 15, 2012 (NZ) 599989
Oct. 1, 2012 (NZ) 602768

(51) Int. Cl. A41D 13/01; F21V 23/02

(52) U.S. Cl. CPC A41D 13/01; F21V 23/023
USPC 362/108; 362/157

(57) ABSTRACT

Apparatus and methods for illuminating garments and articles with light sources such as electroluminescent (EL) panels or LED strips, via open channels attached to the garments. The open channels are configured to securely hold the panels or strips via friction fit, while exposing a large region of the upper surface of the panels or strips. The panels or strips are removably inserted into the open channels, and a control unit is provided for controlling all the panels and/or strips on the garment.

### FIELD OF THE INVENTION

The present invention relates to apparatus and methods for illuminating garments or articles to be worn. In particular, the invention relates to illuminating articles such as safety vests, in order to improve the visibility of the user wearing or carrying the article.

### BACKGROUND TO THE INVENTION

Safety garments, such as safety vests with illuminated panels are known to help protect the wearer by increasing the visibility of the wearer. These safety vests are especially useful for people working on roads or in dark environments, such as workmen, drivers, pedestrians, security personnel, emergency workers, mine workers, etc.

Existing illuminated safety vests have panels of lighting which are fixed to the vests. The panels may be illuminated by various types of light sources such as electroluminescent (EL) panels, light emitting diodes (LED) or organic light emitting diodes (OLED). These are active light sources which require power, normally provided by batteries which are also attached to the safety vests.

One major problem with these existing safety vests is the cost of replacing the vests when dirty, torn or damaged. Another problem is the inconvenience of replacing or recharging the batteries that power the light panels. This issue becomes particularly significant for large teams of users/workers working on locations with limited power supply.

It is therefore an object of this present invention to address these problems by providing safety vests with easily replaceable light panels, improved powering features or to improve the safety of such illuminated vests. It is another object to provide a useful choice of illuminated garment.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect, the present invention broadly consists in a garment or article to be worn or carried comprising:
at least one length of open faced channel fixed to said garment or article, said channel adapted to detachably receive and secure at least one strip or panel of an illuminating light source.

According to another aspect said channel is elongate and comprises a base and two opposed side walls extending from opposing sides of said base, and wherein at least one said side wall includes a lip portion extending from said side wall to secure said strip or panel within said channel.

According to another aspect both said side walls include a lip portion extending from said side wall to secure said strip or panel within said channel.

According to another aspect said lip is substantially parallel to, but spaced apart from, said base and wherein when said strip or panel is inserted into the space between said base and said lip, said strip or panel is held securely said lip, and
a portion of the top face of said strip or panel, adjacent said lip, is exposed.

According to another aspect said lip is configured to secure said strip or panel via a friction fit.

According to another aspect at least one of the two ends of the channel is open to allow insertion of said strip or panel.

According to another aspect said garment includes a plurality of said channels.

According to another aspect said channel is flexible.

According to another aspect said channel is made of extruded plastic.

According to another aspect said channel is fixed to said garment or article by gluing, sewing or riveting the base of said channel to said garment or article.

According to another aspect said channel is removably fixed to said garment or article via means which include hook and loop fasteners, buttons or zips.

According to another aspect said illuminating light source is any one or more of:
a) a strip or panel of LEDs,
b) Electro Luminescent panel
c) a strip or panel of OLEDs.

According to another aspect said strip or panel is enclosed in a substantially transparent plastic sheath.

According to another aspect a pull tag is attached to at least one end of said strip or panel to aid insertion of said strip or panel into said channel.

According to another aspect said pull tag is over-moulded to at least one end of said strip or panel.

According to another aspect said garment further comprises a control unit configured to control the illuminating light source.

According to another aspect said control unit includes a battery power source.

According to another aspect said garment includes a safety relay which discontinues high voltage power supply to said strip or panel when said control unit is disconnected from said strip or panel.

According to another aspect said relay is in said control unit.

According to another aspect said disconnection occurs at a plug or socket and said relay is located in said plug or socket.

According to another aspect said control unit includes a thermal switch which discontinues high voltage power supply to said strip or panel when the temperature in said control unit exceeds a predetermined threshold.

According to another aspect said control unit includes an audio signalling device for providing audible warnings when the charge level of said battery power supply drops below a predetermined threshold.

According to another aspect said audible warnings may be switched off temporarily, but will restart automatically after a predetermined time interval.

According to another aspect said audio signalling device and switch to temporarily turn off said audio signalling device are sealed in a water-resistant seal within or on said control unit.

According to another aspect said control unit includes at least one light source for indicating charge level of said battery source.

According to another aspect a pocket is provided for removably attaching said control unit onto said garment or article, said pocket being made of a substantially transparent plastic.

According to another aspect said control unit includes an integrated circuit controlling any one or more of the following operations:
d) Providing various modes for lighting said strip or panel, including flashing and constant lighting.
e) Protecting charging input voltage against over voltage and reverse-polarity voltage.
f) Controlling and limiting charge current and voltage of said battery power supply to prevent any overcharging of the battery.
g) Protecting said battery from excessive discharge via low-battery cut-off.
h) Limiting output current so that if excessive current is drawn by said panel or strip, power circuitry in said control unit will instantly shut down.
i) Protecting said battery supply and said circuit with a protection circuit module (PCM).

According to another aspect a charging station is provided to recharge said battery power source of said control unit, and wherein said charging station is powered by an electrical outlet and configured to receive at least one control unit.

According to another aspect said charging station recharges said battery power source via inductive power transfer.

According to another aspect said charging station is adapted to gang together with at least one other like charging station, and wherein all ganged charging stations are powered by a power source from a single charging station.

According to another aspect said charging station is additionally or alternatively powered by solar energy.

According to another aspect said control unit includes a USB port for connecting to a computer via USB connection, and said battery supply is rechargeable via said USB connection.

According to another aspect said control unit includes a data logging circuit and microprocessor for collecting and storing data.

According to another aspect said control unit includes a screen for displaying data on said control unit.

According to another aspect said USB port can be used to transfer data between said control unit and a computer.

According to another aspect said data is transferred between said control unit and a computer via wireless means.

According to another aspect said garment or article comprises multiple channels each holding a strip or panel of said light source, wherein all of said strips or panels are electrically connected together, and wherein said control unit controls all of said strips or panels.

According to another aspect said electrical connection between a pair of said strips or panels is via a tensioning connector, which allows the distance between said strips or panels to be reversibly adjusted.

According to another aspect a water-resistant tensioning connector cover is provided to protect said tensioning connector.

According to another aspect said tensioning connector cover is made of a flexible plastic.

According to another aspect said control unit controls all of said strips or panels via an electrical connection to one of said strips or panels.

According to another aspect a water-resistant over-moulded connector is provided to substantially encapsulate and protect said electrical connection between said control unit and said strip or panel.

According to another aspect said over-moulded connector is made of a moulding adhesive or flexible plastic material.

According to another aspect a light-sensitive element for controlling said strip or panel is provided, and wherein said switch turns on said strip or panel when the ambient light level is lower than a predetermined threshold.

According to another aspect said light-sensitive switch is located in or on said water-resistant cover.

According to another aspect said garment or article is of a fluorescent material and includes reflective strips.

In a further aspect the invention broadly consists in a kit for illuminating garments or articles to be worn or carried, comprising:
at least one strip or panel of an illuminating light source,
at least one open channel into which said strip or panel may be removably inserted, and
a control unit for controlling said strip or panel.

According to another aspect said open channel comprises:
a base which is attachable to said garment or article,
two opposed side walls extending from opposing sides of said base, and a top lip extending from at least one sidewall, said top lip being substantially parallel to but spaced apart from the base,
wherein said strip or panel, when inserted into the space between the base and the lip, is held securely by the lip, and wherein
a portion of the top face of said strip or panel, adjacent said lip, is exposed.

According to another aspect said exposed portion of said strip or panel is between said two lips.

According to another aspect at least one of the two ends of the channel are open to allow insertion of said strip or panel.

According to another aspect said channel is flexible.

According to another aspect said channel is substantially the same length as said strip or panel.

According to another aspect said channel is made from extruded plastic.

According to another aspect said channel is permanently attached to said garment or article by gluing, sewing or riveting the base of the channel to said garment or article.

According to another aspect said channel is removably fixed to said garment or article via means which include Velcro, buttons and zips.

According to another aspect said illuminating light source is any one or more of:
j) a strip or panel of LEDs,
k) Electro Luminescent panel
l) a strip or panel of OLEDs.

According to another aspect said strip or panel is enclosed in a substantially transparent plastic sheath.

According to another aspect a pull tag is attached to at least one end of said strip or panel to aid insertion of said strip or panel into said channel.

According to another aspect said pull tag is over-moulded to at least one end of said strip or panel.

According to another aspect said control unit is powered by a battery supply.

According to another aspect said control unit includes a safety relay which discontinues high voltage power supply to said strip or panel when said control unit is disconnected from said strip or panel.

According to another aspect said safety relay operates on a substantially lower voltage than said strip or panel.

According to another aspect said control unit includes a thermal switch which discontinues high voltage power supply to said strip or panel when the temperature in said control unit exceeds a predetermined threshold.

According to another aspect said control unit includes an audio signalling device for providing audible warnings when the charge level of said battery power supply drops below a predetermined threshold.

According to another aspect said audible warnings may be switched off temporarily, but will restart automatically after a predetermined interval.

According to another aspect said audio signalling device and switch to temporarily turn off said audio signalling device are sealed in a water-resistant seal within or on said control unit.

According to another aspect said control unit includes at least one light source for indicating charge level of said battery source.

According to another aspect a pocket is provided for removably attaching said control unit onto said garment or article, said pocket being made of a substantially transparent plastic.

According to another aspect said control unit includes an integrated circuit controlling any one or more of the following operations:
m) Providing various modes for lighting said strip or panel, including flashing and constant lighting.
n) Protecting charging input voltage against over voltage and reverse-polarity voltage.
o) Controlling and limiting charge current and voltage of said battery power supply to prevent any overcharging of the battery.
p) Protecting said battery from excessive discharge via low-battery cut-off.
q) Limiting output current so that if excessive current is drawn by said panel or strip, power circuitry in said control unit will instantly shut down.
r) Protecting said battery supply and said circuit with a protection circuit module (PCM).

According to another aspect a charging station is provided to recharge said battery power source of said control unit, and wherein said charging station is powered by an electrical outlet and configured to receive at least one control unit.

According to another aspect said charging station recharges said battery power source via inductive power transfer.

According to another aspect said charging station is adapted to gang together with at least one other like charging station, and wherein all ganged charging stations are powered by a power source from a single charging station.

According to another aspect said charging station is additionally or alternatively powered by solar energy.

According to another aspect said control unit includes a USB port for connecting to a computer via USB connection, and said battery supply is rechargeable via said USB connection.

According to another aspect said control unit includes a data logging circuit and microprocessor for collecting and recording data.

According to another aspect said control unit includes a screen for displaying data on said control unit.

According to another aspect said USB port can be used to transfer data between said control unit and a computer.

According to another aspect said data is transferred between said control unit and a computer via wireless means.

According to another aspect said kit is used to retrofit an existing garment or article with said illuminating light strips or panels.

According to another aspect said kit comprises multiple light strips or panels and multiple channels, wherein all of said strips or panels are electrically connected together, and wherein said control unit controls all of said strips or panels.

According to another aspect said electrical connection between a pair of said strips or panels is via a tensioning connector, which allows the distance between said strips or panels to be reversibly adjusted.

According to another aspect a water-resistant tensioning connector cover is provided to protect said tensioning connector.

According to another aspect said tensioning connector cover is made of a flexible plastic.

According to another aspect said control unit controls all of said strips or panels via an electrical connection to one of said strips or panels.

According to another aspect a water-resistant over-moulded connector is provided to substantially encapsulate and protect said electrical connection between said control unit and said strip or panel.

According to another aspect said over-moulded connector is made of a moulding adhesive or flexible plastic material.

According to another aspect a light-sensitive element for controlling said strip or panel is provided, wherein said switch turns on said strip or panel when the ambient light level is lower than a predetermined threshold.

According to another aspect said light-sensitive switch is located in or on said water-resistant cover.

In a further aspect the invention broadly consists in a control unit operatively connected to at least one remote strip or panel of an illuminating light source, said strip or panel being removably attached to a garment or article to be worn or carried, said control unit comprising:
i. a housing and
ii. a power supply for said strip or panel.

According to another aspect said power supply is a battery power source located in said housing.

According to another aspect said control unit includes a safety relay, located in said housing, which discontinues high voltage power supply to said strip or panel when said control unit is disconnected from said strip or panel.

According to another aspect said safety relay operates on a substantially lower voltage than said strip or panel.

According to another aspect said control unit includes a thermal switch, located in said housing, which discontinues high voltage power supply to said strip or panel when the temperature in said control unit exceeds a predetermined threshold.

According to another aspect said control unit includes an audio signalling device for providing audible warnings when the charge level of said battery power supply drops below a predetermined threshold.

According to another aspect said audible warnings may be switched off temporarily, but will restart automatically after a predetermined interval.

According to another aspect said audio signalling device and switch to temporarily turn off said audio signalling device are sealed in a water-resistant seal within or on said control unit.

According to another aspect said control unit includes at least one light source for indicating charge level of said battery source.

According to another aspect a water-resistant pocket is provided for removably attaching said control unit onto said garment or article, said water-resistant pocket being made of a substantially transparent plastic.

According to another aspect said control unit includes an integrated circuit controlling any one or more of the following operations:
s) Providing various modes for lighting said strip or panel, including flashing and constant lighting.
t) Protecting charging input voltage against over voltage and reverse-polarity voltage.
u) Controlling and limiting charge current and voltage of said battery power supply to prevent any overcharging of the battery.
v) Protecting said battery from excessive discharge via low-battery cut-off.
w) Limiting output current so that if excessive current is drawn by said panel or strip, power circuitry in said control unit will instantly shut down.
x) Protecting said battery supply and said circuit with a protection circuit module (PCM).

According to another aspect a charging station is provided to recharge said battery power source of said control unit, and wherein said charging station is powered by an electrical outlet and configured to receive at least one control unit.

According to another aspect said charging station recharges said battery power source via inductive power transfer.

According to another aspect said charging station is adapted to gang together with at least one other like charging station, and wherein all ganged charging stations are powered by a power source from a single charging station.

According to another aspect said charging station is additionally or alternatively powered by solar energy.

According to another aspect said control unit includes a USB port for connecting to a computer via USB connection, and said battery supply is rechargeable via said USB connection.

According to another aspect said control unit includes a data logging circuit and microprocessor for collecting and recording data.

According to another aspect said control unit includes a screen for displaying data on said control unit.

According to another aspect said USB port can be used to transfer data between said control unit and a computer.

According to another aspect said data is transferred between said control unit and a computer via wireless means.

The term illuminating light source is intended to mean a device that emits light. It is intended to exclude devices that primarily reflect light.

Examples of suitable light sources include, but are not limited to, light emitting diodes (LED), electroluminescent (EL) and organic light emitting diodes (OLED).

The term “electroluminescent” or “EL” refers to property of certain materials to illuminate up when electrical current is passed through the material.

For brevity, the following description is directed towards illuminated safety vests. However, it should be understood that the methods and apparatus described may be used to illuminate any type of garment or article, such as shoes, jackets, backpacks, helmets, etc.

The term “comprising” as used in this specification and claims means “consisting at least in part of”. When interpreting each statement in this specification and claimsthat includes the term “comprising”, features other than that or those prefaced by the term may also be present. Related terms such as “comprise” and “comprises” are to be interpreted in the same manner.

### BRIEF DESCRIPTION OF THE DRAWINGS

Preferred embodiments of the invention will be described by way of example only and with reference to the drawings, in which:

FIG. 1 is a schematic front view of a safety vest fitted with replaceable EL panels, and a control unit.

FIG. 2 is a schematic rear view of a safety vest fitted with replaceable EL panels and a tensioning connector.

FIG. 3 is a schematic cross-sectional view through an EL panel and its housing channel on a safety vest.

FIG. 4 is a close-up schematic view of a control unit.

FIG. 5 is a perspective view of a multi-unit charging station.

FIG. 6 is a perspective view of several multi-unit charging stations ganged together.

FIG. 7 is a schematic of a power circuit from an El panel to a control unit, incorporating a safety relay.

FIG. 8a is an exterior view showing an over-moulded connector on a section of EL panel.

FIG. 8b is a cross-sectional view through the over-moulded connector of FIG. 8a.

FIG. 9a is an exterior view of an over-moulded connector with light sensor.

FIG. 9b is a cross-sectional view through the over-mould connector and light sensor of FIG. 9a.

FIG. 10a shows tensioning connector connecting two channels and EL panels.

FIG. 10b shows one embodiment of a tensioning connector with a retractable cord reel.

FIG. 11 shows one embodiment of a pull tag fitted to one end of an EL panel to aid insertion/removal from channel.

### DETAILED DESCRIPTION

In the embodiment illustrated in FIG. 1, safety vest 1 is fitted with channels 2, which house EL panels 3 and 4. A single control unit 5 preferably controls all the EL panels on the safety vest 1, and is attached to the safety vest via pocket 6 or other suitable means. Control unit 5 is connected to the EL panels via panel cable 7.

The rear view of the same embodiment is illustrated in FIG. 2. Preferably, a tensioning connector 10 electrically connects the two EL panels 3 and 4 and is enclosed within tensioning connector cover 9.

EL panels 3 and 4 are preferably encapsulated within transparent or translucent sheaths which are completely sealed to increase the water-resistance of the individual panels. The sheath additionally helps to protect the EL panels from mechanical damage, e.g. cracking, or in the case of damage to the panels, will help shield the user from direct contact with the broken EL panels. The sheath is preferably made of a transparent plastic.

The sheathed EL panels are attached to the safety vest 1 via insertion into channels 2. Each channel is preferably of substantially the same length as its associated panel, in order to securely hold the panel against the safety vest. FIG. 3 is a cross-sectional view of an EL panel inserted into a channel on the vest. The channel has side walls 11 which extend slightly over the top of the channel to form lips 12. Lips 12 hold the EL panel securely within the channel. Since lips 12 only project a short distance over the top of the channel, most of the top section is open, which exposes the EL panel allowing uninhibited visibility of the lighted panel. Preferably the side walls of the channels 2 are curved.

Housing the EL panel within a channel with an open top section has several advantages over a covered pocket. Firstly, it prevents dirt, condensation and rainwater from collecting underneath the housing (i.e. on top of the EL panels), which could reduce the luminosity of the EL panels. It will be appreciated that the EL panels may include illuminated shapes, symbols, letters or numbers or combining thereof.

Preferably, the channels 3 are made of a flexible material that can deform to the shape of a user wearing the vest and/or deform due to movement of the user while wearing the vest and remain comfortable.

The channels 2 are preferably made of extruded plastic material, such as silicone, low density polyethylene, polyvinyl chloride, low density polystyrene, or thermoplastic polyurethane (TPU), although any other durable and flexible material may also be used.

The channels 2 may be permanently or releasably attached to the vest. Examples of permanent attachment means include gluing, riveting or sewing the base of the channels directly onto the vest. Releasable attachments means include lock and loop fasteners, zips, buttons, domes etc. Any number of channels in varying configurations may be attached to a single vest, depending, for example, on preference or regulatory requirements.

An EL panel is attached or detached from the vest by sliding the panel into or out of an open end 13 of the channel. Preferably, at least one end of each channel is open, but optionally both ends of each channel may be open, for the EL panel to be inserted. Alternatively, at least one end may be placed with a removable plug to allow the panel to be inserted/removed.

As shown in FIG. 11, each EL panel is preferably provided with pull tag(s) 26 at one or both ends of the panel to enable the user to easily pull the EL panel into and out of the open end(s) 13 of the channel. Pull tag(s) 26 may be attached to the base of the EL panel, below the lighting component of the panel via any suitable means. For example, tag(s) 26 may be attached by being over-moulded directly onto the end(s) of the EL panel, or reiveted or other fastener means that extend through the EL panel. Alternatively, the tab may be adhesively fixed.

The EL panel attachment described provides various flexible options to the user. For example, the safety vests may be sold together with the EL panels, control unit and wiring pre-attached or to be attached later by the user. Further, the safety vests may be supplied with or without channels attached. These vests may also include other high-visibility features such as reflective strips and fluorescent material. The user may customise the number and/or arrangement of the channels on the safety vest. For example, the user could sew additional channels onto the safety vest using a sewing machine.

Additionally, the EL panels, control unit and wiring may be supplied as a separate kit, to allow retrofitting to existing vests. The panels and associated components may be easily removed when the vest needs to be washed, mended or replaced. Additionally, individual EL panels may be replaced when damaged, instead of replacing the entire vest.

Pocket 6 for housing the control unit 5 may also be permanently or releasably attached to the safety vest. For example, pocket 6 may be releasably attached to the safety vest via a clip. The pocket is preferably made of a transparent or translucent plastic, so that indicator lights on the control unit can be easily seen by the user.

FIG. 4 shows a close up schematic of a preferred embodiment of control unit 5 with control circuit board 14, indicator lights 15, warning buzzer 16, plug to EL panel 17, charging plug 18, thermal fuse (cut-off) or switch (cut-out) 19, battery pack 20 and mode selector switch 21. Preferably, all the switches on the control unit 5 are sealed, to preserve the water-resistance of the control unit.

Alternatively, the control unit 5 may be attached to the exterior of the vest. For example, the control unit 5 may be attached by one or more clips, on or more hooks, or even hook and loop type removable fasteners.

Indicator lights 15 are preferably high luminosity sequential LED's programmed to indicate various battery charge levels (e.g. low, medium and full charge). Warning buzzer 16 preferably provides an additional audio alarm to warn the user of low battery charge. The buzzer 16 may be a piezoelectric sensing alarm or any other sound-making component that produces a beeping sound when battery levels are nearly depleted, to remind the user to replace or recharge the battery pack.

The buzzer 16 is preferably enclosed within control unit 5 and preferably does not require any openings in the casing of the control unit for sound penetration, so as not to compromise the water-resistance of the control unit. The buzzer 16 may preferably be switched off temporarily by the user, so that it does not become a continuous annoyance to the user. However, the buzzer 16 is preferably programmed to switch back on again after a set time period, so as to audibly warn the user again of the imminent battery charge depletion. This cycle of manual-off and automatic-on may be repeated until the battery pack is completely depleted.

Control unit 5 preferably includes mode selector switch 21 to allow the user to toggle between various lighting modes of the EL panels. For example, the user could choose between constant light, flashing light or no light. A flashing light may be more noticeable in very dark environments or in environments where there are many other surrounding light sources.

Control circuit board 14 in control unit 5 preferably incorporates one or more of the following safety features, to reduce the risk of failure or fire due to overloading of the control unit:
Input voltage for charge is protected against over voltage and reverse polarity voltage.
An intelligent charge system controls and limits the charge current and voltage of the battery to prevent any overcharging of the battery.
Low-battery cut-off protects the battery from excessive discharge, and the resulting potential damage.
Output current is limited so that if excessive current is drawn by the EL panels, the power circuit will instantly shut down.
Battery pack 20 is fitted with a protection circuit module (PCM) to provide additional protection to circuit board 14.

Thermal fuse 19 on the control unit 5 is preferably fitted to turn off the EL panels when the temperature within the control unit 5 exceeds a specified temperature. This cut-off temperature may be in the range of 40 to 60° C. for example, in order to reduce the risk of fire due to overheating of the control unit 5. This safety feature is especially useful if the vest is to be used in potentially flammable or explosive situations such as underground mines.

Alternatively or additionally, the control unit 5 may incorporate a sealed magnetic switch to eliminate any sparking hazards in flammable or explosive environments.

Sparking may also occur when the user disconnects the (high voltage) control unit 5 from the EL panels in order to replace or recharge the control unit. To eliminate such sparking hazard, relay switch 28 may be incorporated to instantaneously discontinue (high voltage) power supply to the EL panels when the control unit is disconnected.

FIG. 7 is a schematic diagram of a preferred embodiment incorporating the relay circuit. Safety plug 28 of the EL panel 3 includes relay circuitry 31 and connects to plug 17 of control unit 5. The control unit 5 (via an inverter) supplies high voltage alternating current (AC) via AC cable 29 and low voltage direct current (DC) via DC cable 30. The AC supply powers the EL panel via panel cable 7 as described previously. The DC supply powers the relay within safety plug 28. Alternatively, the relay may be located in the control unit.

In order for the control unit 5 to be activated even when it is physically switched on, the DC relay circuit must be complete. The DC relay circuit is only complete when safety plug 28 is plugged into control unit 5. The relay then activates the AC supply to the EL panels. Therefore, when control unit 5 is disconnected from the EL panel by the user, the relay circuit is broken, and high voltage power supply to the EL panel is instantaneously discontinued. Preferably, the relay circuit is broken first when the plug is pulled apart and the relay circuit is completed second when the plug is connected. Preferably, the relay disconnects the high voltage power supply at the control unit. The closing of the relay switch may also incorporate a mechanism to delay the switching on the high voltage circuit.

The relay may be an electronic, electromechanical or magnetic relay requiring a significantly lower voltage than that used to power the EL panels. The voltage range is preferably between 1 and 24 volts, in order to prevent any risk of sparking from the relay circuit. In contrast, the AC supply powering the EL panels is typically in the range of 80 to 120 volts, and therefore poses a significant sparking hazard if the safety relay circuit is not incorporated. Additionally, the safety relay will inhibit high voltage AC power from accidently being switched on when the controller is not connected to the EL panel, thereby leaving an open high-voltage plug that could be accidentally short-circuited, causing a spark. The safety circuit therefore protects against any short-circuiting risk caused by the user or through failure of the electronic control circuit to automatically switch off when control unit 5 is disconnected from the EL panel.

A single control unit 5 preferably controls all the EL panels on the vest. Wire connections are therefore required between plug 17 of control unit 5 to one EL panel, and between the remaining EL panels. In order to protect, water-proof, and hide most of the wiring, over-moulded connector 8 and tensioning connector cover 9 are preferably provided.

FIGS. 8a and 8b show an exterior view of over-moulded connector 8 and a cross-sectional view through the over-moulded connector 8 respectively. The over-moulded connector 8 completely, or at least substantially, encapsulates all the wiring connections 33 between safety plug 28 and EL panel 3. Safety plug 28 is only partially enclosed, leaving an exposed face for connecting to control unit 5.

Over-moulded connector 8 may be made of a low temperature, low pressure molding adhesive via a macromelt process, or other suitably waterproof, flexible and electrically insulating material such as TPU or silicone via, for example, a two-part moulding process. The over-moulded connector 8 protects most of the wiring on the EL panel, so that only the panel cable 7 from control unit 5 to safety plug 28 remains exposed. The reduced length of exposed wire minimises the risk of electrical shock to the user should the wire break due to continual flexing of the safety vest and/or frequent connecting and disconnecting of the plugs. The over-moulding additionally reduces short-circuiting hazards caused by water around the electrical connections to the EL panels.

Wiring between EL panels, such as between EL panels 3 and 4, is preferably provided by a tensioning connector 10.

Tensioning connector 10 enables the length of connection between the EL panels to be extended or reduced as required to fit different sizes of safety vest. The tensioning connector 10 preferably allows the same EL panel kit to be used with vest sizes ranging from very small to very large.

A tensioning connector cover 9 encloses and protects the tensioning connector 10, as seen in FIG. 2. FIG. 10a shows the tensioning connector 10 with cover 9 removed. As shown in FIG. 10b, the tensioning connector 10 preferably includes a retractable cord reel mechanism. Tensioning connector cover 9 is preferable made of silicone, TPU or other suitably flexible, waterproof and electrically insulating material, to protect the tensioning connector in the same way as over-moulded connector 8 as detailed previously.

Preferably, a light-sensitive switch or controller may also be connected to EL panel 3, preferably within over-moulded 8 connector. FIGS. 9a and 9b show an exterior view of over-moulded connector 8 with light sensor 34, and a cross-sectional view through the relevant components respectively. Dedicated circuit board 35 includes a relay switch which activates when a preset low light signal is sensed, to automatically allow power supply to the EL panels in low ambient light levels. Alternatively, the circuit board 35 may include a relay switch which activates when a preset high light signal is sensed, to automatically discontinue power supply to the EL panels in bright ambient light. Alternatively, photo resistive elements may be used as known, to dim the illuminated panels or switch them on and off according to ambient light levels. This is an additional safety measure, in case the user forgets to turn on the EL panels when they are required.

Battery pack 20 in control unit 5 is preferably rechargeable. FIG. 5 shows an embodiment of a multi-unit charging station 22 used to recharge one or more control unit(s) 5 simultaneously. The charging station 22 includes one or more charging slots 23 which receive the control unit 5.

Charging plug 18 on control unit 5 is preferably a sealed contact (ie: exposed conductive contacts) or a close-proximity charging connection which connects wirelessly to the charging station 22 eg: inductive power transfer. The ‘docketing station’ style of charging eliminates the use of plugs and wires. Accordingly, the control unit 5, is sealed thereby improving waterproofness.

Each charging slot 23 is preferably provided with charge indicator lights 24 to indicate the charge level of each individual control unit. Alternatively, or in combination the charger preferably holds the control unit upright so that indicator lights (for power/charge state) can be seen.

The multi-unit charging station 22 may be powered from any electrical outlet such as a wall power outlet, vehicle power outlet, mobile generator, etc. The charging station 22 may alternatively or additionally include solar panels so that the device may be powered by solar power.

Multiple charging stations may be ganged together as shown in FIG. 6, via ganging plug 25. This will enable a greater number of control units 5 to be charged simultaneously from a single power outlet. This modular arrangement allows charging stations to be added only when required, making a flexible and portable charging system.

In addition to recharging via the charging station 22, control unit 5 may preferably be recharged via a computer. Control unit 5 includes one or more Universal Serial Bus (USB) port(s) 26 which may be connected to a computed via a standard USB cord or other connection means.

The USB connection may additionally be used for data transfer. A data logging circuit and microprocessor may be incorporated into control unit 5 to collect data on the activity of the safety vest. Useful data that may be recorded includes one or more of:
the time and date of failures or accidents,
number of recharge and discharge cycles,
hours of operation,
lighting modes used; and
proprietary information such as the name and details of the user. The control unit 5 may also record data from sensors such as light sensors, to help with maintenance and quality control of the safety vest.

The data logs may be viewed directly from control unit 5 (e.g. via a screen incorporated into the control unit), or may be uploaded to a computer via the USB connection. Alternatively, data may be transferred to a computer via sealed external contact points on the housing of the control unit, or any other contactless means.

The foregoing description of the invention includes preferred forms thereof. Modifications may be made thereto without departing from the scope of the invention as defined by the accompanying claims.

1. A garment or article to be worn or carried comprising:
at least one length of open faced channel fixed to said garment or article, said channel adapted to detachably receive and secure at least one strip or panel of an illuminating light source.

2. A garment or article as claimed in claim 1, wherein said channel is elongate and comprises a base and two opposed side walls extending from opposing sides of said base, and wherein at least one said side wall includes a lip portion extending from said side wall to secure said strip or panel within said channel.

3. A garment or article as claimed in claim 2, wherein both said side walls include a lip portion extending from said side wall to secure said strip or panel within said channel.

4. A garment or article as claimed in claim 2 or claim 3, wherein said lip is substantially parallel to, but spaced apart from, said base and wherein when said strip or panel is inserted into the space between said base and said lip, said strip or panel is held securely said lip, and
a portion of the top face of said strip or panel, adjacent said lip, is exposed.

5. A garment or article as claimed in any one of claims 2 to 4, wherein said lip is configured to secure said strip or panel via a friction fit.

6. A garment or article as claimed in any one of claims 2 to 5, wherein at least one of the two ends of the channel is open to allow insertion of said strip or panel.

7. A garment or article as claimed in any one of the preceding claims, wherein said garment includes a plurality of said channels.

8. A garment or article as claimed in any one of the preceding claims, wherein said channel is flexible.

9. A garment or article as claimed in any one of the preceding claims, wherein said channel is made of extruded plastic.

10. A garment or article as claimed in any one of the preceding claims, wherein said channel is fixed to said garment or article by gluing, sewing or riveting the base of said channel to said garment or article.

11. A garment or article as claimed in any one of the preceding claims, wherein said channel is removably fixed to said garment or article via means which include hook and loop fasteners, buttons or zips.

12. A garment or article as claimed in any one of the preceding claims, wherein said illuminating light source is any one or more of:
a) a strip or panel of LEDs,
b) Electro Luminescent panel
c) a strip or panel of OLEDs.

13. A garment or article as claimed in any one of the preceding claims, wherein said strip or panel is enclosed in a substantially transparent plastic sheath.

14. A garment or article as claimed in any one of the preceding claims, wherein a pull tag is attached to at least one end of said strip or panel to aid insertion of said strip or panel into said channel.

15. A garment or article as claimed in claim 14, wherein said pull tag is over-moulded to at least one end of said strip or panel.

16. A garment or article as claimed in any one of the preceding claims, wherein said garment further comprises a control unit configured to control the illuminating light source.

17. A garment or article as claimed in claim 16, wherein said control unit includes a battery power source.

18. A garment or article as claimed in claim 16 or 17, wherein said garment includes a safety relay which discontinues high voltage power supply to said strip or panel when said control unit is disconnected from said strip or panel.

19. A garment or article as claimed in claim 16 or 17, wherein said relay is in said control unit.

20. A garment or article as claimed in claim 16 or 17, wherein said disconnection occurs at a plug or socket and said relay is located in said plug or socket.

21. A garment or article as claimed in any one of claims 16 to 20, wherein said control unit includes a thermal switch which discontinues high voltage power supply to said strip or panel when the temperature in said control unit exceeds a predetermined threshold.

22. A garment or article as claimed in any one of claims 17 to 21, wherein said control unit includes an audio signalling device for providing audible warnings when the charge level of said battery power supply drops below a predetermined threshold.

23. A garment or article as claimed in claim 22, wherein said audible warnings may be switched off temporarily, but will restart automatically after a predetermined time interval.

24. A garment or article as claimed in claim 22 or 23, wherein said audio signalling device and switch to temporarily turn off said audio signalling device are sealed in a water-resistant seal within or on said control unit.

25. A garment or article as claimed in any one of claims 19 to 24, wherein said control unit includes at least one light source for indicating charge level of said battery source.

26. A garment or article as claimed in any one of claims 16 to 25, wherein a pocket is provided for removably attaching said control unit onto said garment or article, said pocket being made of a substantially transparent plastic.

27. A garment or article as claimed in any one of claims 17 to 26, wherein said control unit includes an integrated circuit controlling any one or more of the following operations:
a) Providing various modes for lighting said strip or panel, including flashing and constant lighting.
b) Protecting charging input voltage against over voltage and reverse-polarity voltage.
c) Controlling and limiting charge current and voltage of said battery power supply to prevent any overcharging of the battery.
d) Protecting said battery from excessive discharge via low-battery cut-off.
e) Limiting output current so that if excessive current is drawn by said panel or strip, power circuitry in said control unit will instantly shut down.
f) Protecting said battery supply and said circuit with a protection circuit module (PCM).

28. A garment or article as claimed in any one of claims 17 to 27, wherein a charging station is provided to recharge said battery power source of said control unit, and wherein said charging station is powered by an electrical outlet and configured to receive at least one control unit.

29. A garment or article as claimed in claim 28, wherein said charging station recharges said battery power source via inductive power transfer.

30. A garment or article as claimed in claim 28 or 29, wherein said charging station is adapted to gang together with at least one other like charging station, and wherein all ganged charging stations are powered by a power source from a single charging station.

31. A garment or article as claimed in any one of claims 28 to 30, wherein said charging station is additionally or alternatively powered by solar energy.

32. A garment or article as claimed in any one of claims 17 to 31, wherein said control unit includes a USB port for connecting to a computer via USB connection, and said battery supply is rechargeable via said USB connection.

33. A garment or article as claimed in any one of claims 16 to 32, wherein said control unit includes a data logging circuit and microprocessor for collecting and storing data.

34. A garment or article as claimed in claim 33, wherein said control unit includes a screen for displaying data on said control unit.

35. A garment or article as claimed in claim 33 or 34, wherein said USB port can be used to transfer data between said control unit and a computer.

36. A garment or article as claimed in claim 33 or 34, wherein said data is transferred between said control unit and a computer via wireless means.

37. A garment or article as claimed in any one of claims 16 to 36, wherein said garment or article comprises multiple channels each holding a strip or panel of said light source, wherein all of said strips or panels are electrically connected together, and wherein said control unit controls all of said strips or panels.

38. A garment or article as claimed in claim 37, wherein said electrical connection between a pair of said strips or panels is via a tensioning connector, which allows the distance between said strips or panels to be reversibly adjusted.

39. A garment or article as claimed in claim 38, wherein a water-resistant tensioning connector cover is provided to protect said tensioning connector.

40. A garment or article as claimed in claim 39, wherein said tensioning connector cover is made of a flexible plastic.

41. A garment or article as claimed in any one of claims 37 to 40, wherein said control unit controls all of said strips or panels via an electrical connection to one of said strips or panels.

42. A garment or article as claimed in claim 41, wherein a water-resistant over-moulded connector is provided to substantially encapsulate and protect said electrical connection between said control unit and said strip or panel.

43. A garment or article as claimed in claim 42, wherein said over-moulded connector is made of a moulding adhesive or flexible plastic material.

44. A garment or article as claimed in any one of the preceding claims, wherein a light-sensitive element for controlling said strip or panel is provided, and wherein said switch turns on said strip or panel when the ambient light level is lower than a predetermined threshold.

45. A garment or article as claimed in claim 44, wherein said light-sensitive switch is located in or on said water-resistant cover.

46. A garment or article as claimed in any one of the preceding claims, wherein said garment or article is of a fluorescent material and includes reflective strips.

47. A kit for illuminating garments or articles to be worn or carried, comprising:
at least one strip or panel of an illuminating light source,
at least one open channel into which said strip or panel may be removably inserted, and
a control unit for controlling said strip or panel.

48. A kit as claimed in claim 47, wherein said open channel comprises:
a base which is attachable to said garment or article,
two opposed side walls extending from opposing sides of said base, and a top lip extending from at least one sidewall, said top lip being substantially parallel to but spaced apart from the base,
wherein said strip or panel, when inserted into the space between the base and the lip, is held securely by the lip, and wherein
a portion of the top face of said strip or panel, adjacent said lip, is exposed.

49. A kit as claimed in claim 48 wherein top lips extend from both sidewalls, and wherein said exposed portion of said strip or panel is between said two lips.

50. A kit as claimed in claim 48 or 49, wherein at least one of the two ends of the channel are open to allow insertion of said strip or panel.

51. A kit as claimed in any one of claims 47 to 50, wherein said channel is flexible.

52. A kit as claimed in any one of claims 47 to 51, wherein said channel is substantially the same length as said strip or panel.

53. A kit as claimed in any one of claims 47 to 52, wherein said channel is made from extruded plastic.

54. A kit as claimed in any one of claims 47 to 53, wherein said channel is permanently attached to said garment or article by gluing, sewing or riveting the base of the channel to said garment or article.

55. A kit as claimed in any one of claims 47 to 53, wherein said channel is removably fixed to said garment or article via means which include Velcro, buttons and zips.

56. A kit as claimed in any one of claims 47 to 55, wherein said illuminating light source is any one or more of:
a) a strip or panel of LEDs,
b) Electro Luminescent panel
c) a strip or panel of OLEDs.

57. A kit as claimed in any one of claims 47 to 56 wherein said strip or panel is enclosed in a substantially transparent plastic sheath.

58. A kit as claimed in any one of claims 47 to 57, wherein a pull tag is attached to at least one end of said strip or panel to aid insertion of said strip or panel into said channel.

59. A kit as claimed in claim 58, wherein said pull tag is over-moulded to at least one end of said strip or panel.

60. A kit as claimed in any one of claims 47 to 59, wherein said control unit is powered by a battery supply.

61. A kit as claimed in any one of claims 47 to 60, wherein said control unit includes a safety relay which discontinues high voltage power supply to said strip or panel when said control unit is disconnected from said strip or panel.

62. A kit as claimed in claim 61, wherein said safety relay operates on a substantially lower voltage than said strip or panel.

63. A kit as claimed in any one of claims 47 to 62, wherein said control unit includes a thermal switch which discontinues high voltage power supply to said strip or panel when the temperature in said control unit exceeds a predetermined threshold.

64. A kit as claimed in any one of claims 60 to 63, wherein said control unit includes an audio signalling device for providing audible warnings when the charge level of said battery power supply drops below a predetermined threshold.

65. A kit as claimed in claim 64, wherein said audible warnings may be switched off temporarily, but will restart automatically after a predetermined interval.

66. A kit as claimed in claim 65, wherein said audio signalling device and switch to temporarily turn off said audio signalling device are sealed in a water-resistant seal within or on said control unit.

67. A kit as claimed in any one of claims 60 to 66, wherein said control unit includes at least one light source for indicating charge level of said battery source.

68. A kit as claimed in any one of claims 47 to 67, wherein a pocket is provided for removably attaching said control unit onto said garment or article, said pocket being made of a substantially transparent plastic.

69. A kit as claimed in any one of claims 60 to 68, wherein said control unit includes an integrated circuit controlling any one or more of the following operations:
a) Providing various modes for lighting said strip or panel, including flashing and constant lighting.
b) Protecting charging input voltage against over voltage and reverse-polarity voltage.
c) Controlling and limiting charge current and voltage of said battery power supply to prevent any overcharging of the battery.
d) Protecting said battery from excessive discharge via low-battery cut-off.
e) Limiting output current so that if excessive current is drawn by said panel or strip, power circuitry in said control unit will instantly shut down.
f) Protecting said battery supply and said circuit with a protection circuit module (PCM).

70. A kit as claimed in any one of claims 60 to 69, wherein a charging station is provided to recharge said battery power source of said control unit, and wherein said charging station is powered by an electrical outlet and configured to receive at least one control unit.

71. A kit as claimed in claim 70, wherein said charging station recharges said battery power source via inductive power transfer.

72. A kit as claimed in claim 70 or 71, wherein said charging station is adapted to gang together with at least one other like charging station, and wherein all ganged charging stations are powered by a power source from a single charging station.

73. A kit as claimed in any one of claims 70 to 72, wherein said charging station is additionally or alternatively powered by solar energy.

74. A kit as claimed in any one of claims 60 to 73, wherein said control unit includes a USB port for connecting to a computer via USB connection, and said battery supply is rechargeable via said USB connection.

75. A kit as claimed in any one of claims 47 to 74, wherein said control unit includes a data logging circuit and microprocessor for collecting and recording data.

76. A kit as claimed in claim 75, wherein said control unit includes a screen for displaying data on said control unit.

77. A kit as claimed in claim 75 or 76, wherein said USB port can be used to transfer data between said control unit and a computer.

78. A kit as claimed in claim 75 or 76, wherein said data is transferred between said control unit and a computer via wireless means.

79. A kit as claimed in any one of claims 47 to 78, wherein said kit is used to retrofit an existing garment or article with said illuminating light strips or panels.

80. A kit as claimed in any one of claims 47 to 79, wherein said kit comprises multiple light strips or panels and multiple channels, wherein all of said strips or panels are electrically connected together, and wherein said control unit controls all of said strips or panels.

81. A kit as claimed in claim 80, wherein said electrical connection between a pair of said strips or panels is via a tensioning connector, which allows the distance between said strips or panels to be reversibly adjusted.

82. A kit as claimed in claim 81, wherein a water-resistant tensioning connector cover is provided to protect said tensioning connector.

83. A kit as claimed in claim 82, wherein said tensioning connector cover is made of a flexible plastic.

84. A kit as claimed in any one of claims 80 to 83, wherein said control unit controls all of said strips or panels via an electrical connection to one of said strips or panels.

85. A kit as claimed in claim 84, wherein a water-resistant over-moulded connector is provided to substantially encapsulate and protect said electrical connection between said control unit and said strip or panel.

86. A kit as claimed in claim 85, wherein said over-moulded connector is made of a moulding adhesive or flexible plastic material.

87. A kit as claimed in any one of claims 47 to 86, wherein a light-sensitive element for controlling said strip or panel is provided, wherein said switch turns on said strip or panel when the ambient light level is lower than a predetermined threshold.

88. A kit as claimed in claim 87, wherein said light-sensitive switch is located in or on said water-resistant cover.

89. A control unit operatively connected to at least one remote strip or panel of an illuminating light source, said strip or panel being removably attached to a garment or article to be worn or carried, said control unit comprising:
i. a housing and
ii. a power supply for said strip or panel.

90. A control unit as claimed in claim 89, wherein said power supply is a battery power source located in said housing.

91. A control unit as claimed in any one of claims 89 to 90, wherein said control unit includes a safety relay, located in said housing, which discontinues high voltage power supply to said strip or panel when said control unit is disconnected from said strip or panel.

92. A control unit as claimed in claim 91, wherein said safety relay operates on a substantially lower voltage than said strip or panel.

93. A control unit as claimed in any one of claims 89 to 92, wherein said control unit includes a thermal switch, located in said housing, which discontinues high voltage power supply to said strip or panel when the temperature in said control unit exceeds a predetermined threshold.

94. A control unit as claimed in any one of claims 90 to 93, wherein said control unit includes an audio signalling device for providing audible warnings when the charge level of said battery power supply drops below a predetermined threshold.

95. A control unit as claimed in claim 94, wherein said audible warnings may be switched off temporarily, but will restart automatically after a predetermined interval.

96. A control unit as claimed in claim 95, wherein said audio signalling device and switch to temporarily turn off said audio signalling device are sealed in a water-resistant seal within or on said control unit.

97. A control unit as claimed in any one of claims 90 to 96, wherein said control unit includes at least one light source for indicating charge level of said battery source.

98. A control unit as claimed in any one of claims 89 to 97, wherein a water-resistant pocket is provided for removably attaching said control unit onto said garment or article, said water-resistant pocket being made of a substantially transparent plastic.

99. A control unit as claimed in any one of claims 90 to 98, wherein said control unit includes an integrated circuit controlling any one or more of the following operations:
a) Providing various modes for lighting said strip or panel, including flashing and constant lighting.
b) Protecting charging input voltage against over voltage and reverse-polarity voltage.
c) Controlling and limiting charge current and voltage of said battery power supply to prevent any overcharging of the battery.
d) Protecting said battery from excessive discharge via low-battery cut-off,
e) Limiting output current so that if excessive current is drawn by said panel or strip, power circuitry in said control unit will instantly shut down.
f) Protecting said battery supply and said circuit with a protection circuit module (PCM).

100. A control unit as claimed in any one of claims 90 to 99, wherein a charging station is provided to recharge said battery power source of said control unit, and wherein said charging station is powered by an electrical outlet and configured to receive at least one control unit.

101. A control unit as claimed in claim 100, wherein said charging station recharges said battery power source via inductive power transfer.

102. A control unit as claimed in claim 100 or 101, wherein said charging station is adapted to gang together with at least one other like charging station, and wherein all ganged charging stations are powered by a power source from a single charging station.

103. A control unit as claimed in any one of claims 100 to 102, wherein said charging station is additionally or alternatively powered by solar energy.

104. A control unit as claimed in any one of claims 90 to 103, wherein said control unit includes a USB port for connecting to a computer via USB connection, and said battery supply is rechargeable via said USB connection.

105. A control unit as claimed in claim 89 to 104, wherein said control unit includes a data logging circuit and microprocessor for collecting and recording data.

106. A control unit as claimed in claim 105, wherein said control unit includes a screen for displaying data on said control unit.

107. A control unit as claimed in claim 105 or 106, wherein said USB port can be used to transfer data between said control unit and a computer.

108. A control unit as claimed in claim 105 or 106, wherein said data is transferred between said control unit and a computer via wireless means.

109. A garment or article substantially as herein described and with reference to any one or more on the drawings.

110. A kit of parts for retro-fitting a garment or article with illuminating elements substantially as herein described and/or with reference to any one or more on the drawings.

111. A spark reducing connector substantially as herein described and/or with reference to any one or more on the drawings.

112. A tensioning connector substantially as herein described and/or with reference to any one or more on the drawings.

113. A charger adapted to gang together with like chargers substantially as herein described and/or with reference to any one or more on the drawings.
